(19) United States
(12) Patent Application Publication
(10) Pub. No.: US 2022/0129003 A1
(43) Pub. Date: Apr. 28, 2022

(54) SENSOR METHOD FOR THE PHYSICAL, IN PARTICULAR OPTICAL, DETECTION OF AT LEAST ONE UTILIZATION OBJECT, IN PARTICULAR FOR THE DETECTION OF AN ENVIRONMENT FOR THE GENERATION, IN PARTICULAR, OF A SAFETY DISTANCE BETWEEN OBJECTS

(71) Applicants: Markus GARCIA, Schindellegi (CH); Thomas ZELLWEGER, Oppligen (CH)

(72) Inventors: Markus GARCIA, Schindellegi (CH); Thomas ZELLWEGER, Oppligen (CH)

(21) Appl. No.: 17/502,394

(22) Filed: Oct. 15, 2021

(30) Foreign Application Priority Data
Oct. 22, 2020 (DE) 10 2020 127 797.0

(51) Int. Cl. G05D 1/02; G06T 19/20; G01S 17/894; G06T 7/246; G06T 7/33

(52) U.S. Cl. CPC G05D 1/0231; G06T 19/20; G05D 1/0055; G06T 7/246; G06T 7/33; G01S 17/894

(57) ABSTRACT

The invention relates to a sensor method for the physical, in particular optical, detection of at least one utilization object, in particular for the detection of an environment for generating, in particular a safety distance between objects, comprising the provision of the utilization object, carrying out of at least two optical, in particular two-dimensional, sensor images of the utilization object, the images being taken each from different angles and/or different positions relative to the utilization object. Wherein in a further step at least one processing unit is provided, by means of which the utilization object and/or an identification tool clearly, preferably unambiguously, assigned to the utilization object is physically detected, from which at least one characteristic value of the utilization object is obtained, in particular so that the safety distance between two adjacent objects, in particular utilization objects, is maintained.

The present application relates to a sensor method for the physical, in particular optical, detection at least one utilization object, in particular for detection of an environment for the generation of, in particular a safety distance between objects. Previous methods for detecting distances between adjacent utilization objects and for assigning a utilization object to a utilization object class are inexpensive, but quite inaccurate. Usually, a camera image of a utilization object is taken in order to identify it on the basis of its structural and/or haptic features.

A solution of the aforementioned problem is therefore represented by claim 1 as claimed and presented herein.

It is therefore the task of the present invention to offer a sensor method for the physical, in particular optical, detection of at least one utilization object, in particular for the detection of an environment for generating, in particular, a safety distance between objects, which is not only inexpensive and time-saving, but also offers a very particularly high accuracy in the calculation of a safety distance between two utilization objects, for example two vehicles, in particular during road traffic.

According to at least one embodiment, the sensor method presented herein for the physical, in particular optical, detection of at least one utilization object, in particular for the detection of an environment for generating, in particular a safety distance between objects, comprises the provision of at least an utilization object. The utilization object may generally be an object, in particular a three-dimensional object, which is supplied or is to be supplied to a utilization or which is contained in an utilization. In this context, the term “utilize” within the meaning of the application means any handling with regard to a purpose.

According to at least one embodiment, in particular in a second step, at least two optical, in particular two-dimensional, sensor images of the utilization object are taken, the images being taken each from different angles and/or different positions relative to the utilization object, so that an utilization object image collection of the utilization object is formed and, starting from the utilization object image collection and using the optical images, at least one three-dimensional image of the utilization object, for example also of its environment, is generated by an implementation device, three-dimensional image of the utilization object, for example also of its environment, is generated by an implementation device on the basis of the utilization object image collection and using the optical images, in particular where, in a further step, at least one processing unit is provided, by means of which the utilization object and/or an identification tool assigned clearly, preferably unambiguously, to the utilization object is physically detected, from which at least one characteristic value of the utilization object is obtained, in particular so that the safety distance between two adjacent objects, in particular utilization objects, is maintained.

According to at least one embodiment, the three-dimensional image is an approximation image formed basically by the accurately taken two-dimensional images and image transition regions, the transition regions connecting the two-dimensional images to form the three-dimensional image.

According to at least one embodiment, the transition regions are, in optical terms, a pixel-like (mixed) representation of two directly adjacent edge regions of the two-dimensional images, wherein a transition region is formed as a sharply definable dividing line between the two two-dimensional images. In this context, “sharp” may mean that the transition region comprises at least one pixel line along a continuous line. This may mean that in order to connect the two images along the line, one pixel follows the preceding pixel, but in width there is always only one pixel along the line, i.e. the connecting line. Such a transition may therefore be described as sharp or edge-like within the meaning of the application.

According to at least one embodiment, each two-dimensional image is decomposed into individual data, preferably data classes, and based on this data class generation, the data classes are assembled to form the three-dimensional image, in particular using an AI machine.

For the purposes of the application, an “AI machine” means such a machine, for example, such a device, which has an AI entity. Artificial intelligence is an entity (or a collective set of cooperative entities) capable of receiving, interpreting, and learning from input and exhibiting related and flexible behaviours and actions that help the entity achieve a particular goal or objective over a period of time.

In at least one embodiment, the AI machine is set up and intended for triggering an alarm in the event of a safety distance being undershot. For this purpose, even only a small part of the observation of the recorded data can serve, because the AI then learns fully automatically, from the past, which dimensions the utilization object has and from when a safety distance is undershot.

According to at least one embodiment, the data classes are assembled into data class point clouds to generate the three-dimensional image.

According to at least one embodiment, the data classes of different point clouds can be used to calculate a distance between the point clouds and thus not the dimensions of the utilization object itself, but it is also possible to use point clouds of neighboured vehicles independently of this in order to calculate neighboured distances, i.e. safety distances. To calculate the distances between two neighboured point clouds, the locations of the highest point density of both clouds can be used as the distance between two point clouds.

The way to create a three-dimensional view of an object is possible in many different ways. The development of photogrammetry continues to advance. In at least one possible embodiment, the, in particular fully automatic, generation of high-density point clouds from freely taken camera images, for example the two-dimensional camera images described here. Even in the case of areas that are hardly distinguishable in terms of colour, the smallest texture differences on the object are sufficient to generate almost noise-free and detailed 3D point clouds. The highly accurate and highly detailed models have almost laser scan quality.

To generate the 3D point clouds, two-dimensional images of various views of the utilization object are recorded. From the data obtained, the positions of the images at the time of recording can now be created, in particular fully automatically, the sensor can calibrate the camera and finally calculates a 3D point cloud of the utilization object, in particular in almost laser scan quality.

In the next step, a coordinate system can be defined using natural points, such as the corners or edges of the utilization object, and at least one known distance, such as a wall length. If the images have GPS information, as in the case of photos from drones, the definition of the coordinate system can be done entirely automatically by georeferencing.

Afterwards there is the possibility to define the point cloud in its borders. Thus, no unnecessary elements, which, for example, were visible in the background of the photos, interfere with the further use of the point cloud. These boundaries are comparable to a clipping box.

In general, the following can be said about the creation of a point cloud by means of photogrammetry: The better the quality of the photos in terms of resolution and views of the object—the better and more detailed the point cloud will be generated. The same applies to the entirety of the point cloud—if only the exterior views of a building are photographed, a point cloud of a building enclosure is obtained. For a point cloud with exterior and interior views, the software needs additional image material of the premises as well as a connection between interior and exterior. Such a connection is, for example, a photographed door sill—in this way, the reference can be recognized via so-called connection points. The result is an utilization object, which is reproduced holistically in the point cloud with exterior views as well as interior rooms.

Once a point cloud of the object has been created, it can be displayed graphically on a screen. Point clouds can correspond to the data classes described here. Each point cloud can then be assigned to one, preferably exactly one, data class. Also, two or more point clouds may be assigned to one data class or, the other way round, two data classes may be assigned to one point cloud.

The characteristic value can be a real number greater than 0, but it is also conceivable that the characteristic value is composed of various partial characteristic values. An utilization object can therefore have, for example, a partial characteristic value with respect to an external colour, a further characteristic value with respect to maximum dimensions in height and width and/or depth, and a further partial characteristic value with respect to weight. For example, such a characteristic value may therefore be formed by a combination of these three partial characteristic values. A combination may take the form of a sum or a fraction. Preferably, however, the characteristic value is determined in the form of a sum of the aforementioned partial characteristic values. However, the individual partial characteristic values can also be included in the summation with different weighting. For this purpose, it is conceivable that each partial characteristic value has a first weight factor as a weight factor, the second partial characteristic value has a second weight factor and a third partial characteristic value has a third weight factor in accordance with the formula:

K=G1*K1+G2*K2+G3*K3,

where the values K1 to K3 represent the respective partial values and the factors G1 to G3 (which represent real positive numbers) denote respective weighting factors of the partial characteristic values. The utilization object classification presented here can be a purely optical comparison between the utilization object recorded with a camera mentioned above and a utilization object template stored in a database in an optical manner.

According to at least one embodiment, the utilization object classification is performed in that the characteristic value is compared with at least one in a database of the processing unit and/or with a database of an external CPU, and the processing unit and/or the CPU and/or the user himself, selects a database object corresponding to the characteristic value and displays it on a screen of the processing unit, so that a camera image of the utilization object together with the database object is at least partially optically superimposed and/or displayed next to each other on the screen, in particular and further wherein carrying out at least one physical acquisition process, for example by a user and/or an implementation device, in particular at least one camera image, of the utilization object, so that the utilization object is acquired in such a way that an image of the utilization object acquired by the acquisition process is displayed identically or scaled identically with the database object displayed on the screen at the same time, wherein by the acquisition process the utilization object is assigned by the processing unit and/or the CPU and/or the user to at least one utilization object class, for example a vehicle type.

According to at least one embodiment, the physical acquisition process comprises at least one temporal acquisition sequence, wherein during the acquisition sequence at least two different acquisitions of the utilization object being carried out, wherein each acquisition being associated with at least one database object.

According to at least one embodiment, at least one temporal sequential acquisition instruction of the temporal acquisition sequence for acquiring the at least two images is scanned on the screen after the characteristic acquisition and for the utilization object classification.

For example, the acquisition sequence captures an instruction to an implementation device and/or a user to photograph the utilization object at different angles, different distances with different colour contrasts, or the like to facilitate identification with a utilization object stored in the database.

It is conceivable that the utilization object is a vehicle, for example a BMW 3-series. The utilization object itself can, for example, have a spoiler and/or be lowered. If a corresponding utilization object is now not also stored in the database with an additional spoiler and a lowered version, but if the database only generally has a basic model of a BMW 3-series, the processing unit and/or the database and/or the external CPU can nevertheless select this basic 3-series model as the closest match to the utilization object, for example also because the characteristic values of the utilization object are identical, for example on the basis of a vehicle badge.

Therefore, with the aforementioned utilization object classification in combination with the corresponding implementation based on the physical acquisition process, it may be achieved that by the acquisition process the utilization object is assigned by the processing unit and/or the CPU and/or the user to at least one utilization object class, for example a vehicle type.

The vehicle type can be, as already described above, for example a BMW of the 3-series class or any other vehicle registered on German roads or the international road system.

According to at least one embodiment, at least one temporal sequential acquisition instruction of the temporal acquisition sequence the acquisition of at least two images takes place after the characteristic acquisition and to the utilization object class identification on the screen. In particular, such a method step is traversed along this lateral acquisition sequence. The acquisition sequence may therefore comprise, with respect to the location, to an acquisition brightness or the like, precise instructions to the user and/or to an implementation device, so that along predetermined points the processing unit, which preferably comprises an optical camera, optically deflects the utilization object.

For more precise orientation at specific orientation points of the utilization object, at least one, but preferably several orientation points may be attached to the utilization object, preferably also in a detachable manner. Such orientation points may be marking elements which the camera of the processing unit can pick up particularly easily. For example, the marking elements are bar codes or bar codes and/or NFC chips.

Such marking elements can therefore also be passive components. However, it is also conceivable that such marking elements can be detachably applied to the utilization object, for example glued on. Such utilization objects may have their own power supply, for example a battery supply. Such battery-powered marking elements may emit electromagnetic radiation in the optically visible or invisible, for example infrared or microwave, range, which may be detected by a locating element of the processing unit, thereby enabling the processing unit to determine in which position it is located relative to the utilization object.

Alternatively or additionally, however, it is also conceivable that the marking elements are virtual marking elements which are loaded from the database and which, like the utilization object itself, are displayed from the database as an image, for example as a third image together with a camera image of the utilization object and accordingly an appearance of the utilization object loaded virtually from the database, on the screen of the utilization object, may therefore, just like the database objects (which may represent the utilization objects in virtual terms and which are stored in the database), also be stored as further database objects in the database of the processing unit and/or the external CPU. For example, both the utilization object and the further database object (at least one marking element) can be loaded together into the processing unit and/or displayed on the screen of the processing unit with one and the same characteristic value.

According to at least one embodiment, the characteristic value is taken, in particular scanned, from an identification tool, for example a usage badge of the utilization object. The characteristic value is therefore likewise preferably recorded fully automatically by the processing unit, which comprises, for example, an optical camera. Preferably, it is no longer necessary for the user and/or the implementation device to have to manually enter the characteristic value into the processing unit.

According to at least one embodiment, the processing unit comprises or is a smartphone or a camera. If the processing unit is a smartphone or a camera, it may be hand-held as mentioned above.

According to at least one embodiment, the processing unit is attached to a receiving element, which moves relative to the utilization object according to the specifications by the acquisition sequence. The processing unit may therefore move together with the recording element relative to the utilization object according to the acquisition sequence. Although in such a case, the processing unit may be or comprise a smartphone or a camera and the processing unit may still be a manageable processing unit. However, this is attached to a larger unit, namely the receiving element. Preferably, the recording element comprises all necessary components to be able to move along the utilization object fully automatically or by manual force of the user.

According to at least one embodiment, the recording element is a drone which is steered relative to the utilization object according to the acquisition sequence in order to be able to carry out the individual images preferably along or at the aforementioned marking elements.

For the purposes of the invention, a “drone” may be an unmanned vehicle, preferably an unmanned aerial vehicle with one or more helicopter rotors. The drone may then be controlled wirelessly or wired via a control device by the user and/or by the implementation device, either manually or fully automatically, and thus steered.

By means of the drone, it is possible in this respect to proceed in a very space-saving manner when photographing the utilization object around the utilization use. In particular, a safety distance of the utilization object to other utilization objects, for example other cars of a car showroom, can be dispensed with, so that the drone preferably hovers over the individual positions to be photographed in accordance with the determination sequence, without other utilization objects not involved having to be moved very far away. The drone would then simply approach the utilization object from above and, for example, also drive into the interior of the car in order to also be able to take interior photos.

According to at least one embodiment, the acquisition sequence also comprises control data on the flight altitude of the drone, so that the drone flies laterally, preferably fully automatically, along the acquisition sequence. Once, for example, on the basis of the above-mentioned marking elements, a specific acquisition sequence, which may be predetermined by the user and/or implementation device, is called up by the processing unit, a fully automatic process can be run at the end of which there can be the unambiguous or preferably the one-to-one identification of the utilization object with a utilization object stored in the database.

According to at least one embodiment, the sensor device for the physical, in particular optical, detection of at least one utilization object, in particular for the detection of an environment for generating, in particular a safety distance between objects comprises the provision of the utilization object as well as at least one acquisition unit for carrying out at least two optical, in particular two-dimensional, sensor images of the utilization object, wherein the images are taken each from different angles and/or different positions relative to the utilization object, so that a utilization object image collection of the utilization object is formed, wherein by means of an implementation device, starting from the utilization object image collection and using the optical images, at least one three-dimensional image of the utilization object, for example also of its environment, can be generated, in particular wherein by means of a processing unit by means of which the utilization object and/or an identification tool clearly, preferably unambiguously, assigned to the utilization object can be physically detected, from which at least one characteristic value of the utilization object can be obtained, in particular so that the safety distance between two adjacent objects, in particular utilization objects, can be maintained.

In this regard, the device described herein has the same features as the method described herein and vice versa.

An aspect of the invention may further be that by means of the processing unit and/or the CPU at least one physical capturing process, in particular at least one camera image of the utilization object based on the database object displayed on the screen, is performable such that the user acquires the utilization object, that an image of the utilization object acquired by the acquisition process is displayed identically or scaled identically to the database object displayed on the screen at the same time, wherein the processing unit and/or the CPU and/or the user can assign the utilization object to at least one utilization object class, for example a vehicle type, by the acquisition process.

The further embodiments of the device described above may be set forth in the same manner, and in particular with the same features, as the method described above.

Further advantages and embodiments will be apparent from the accompanying drawings.

Show in it:

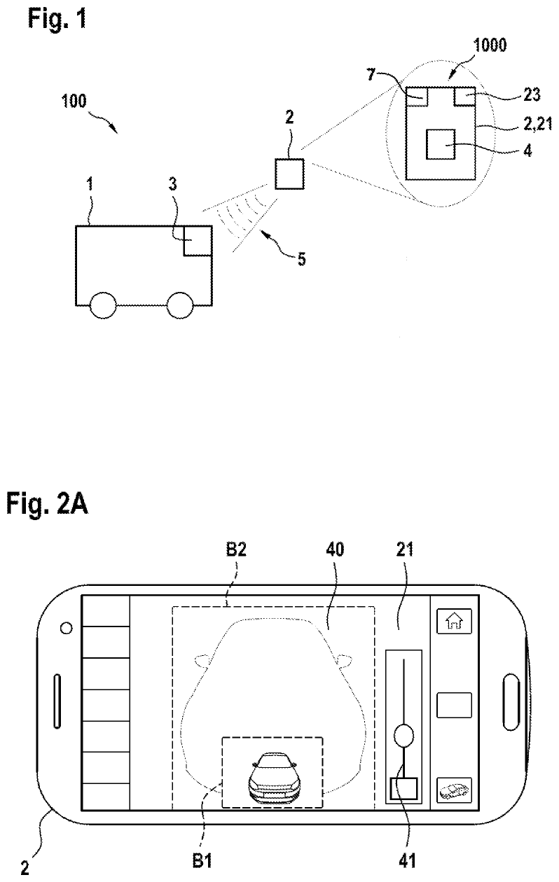

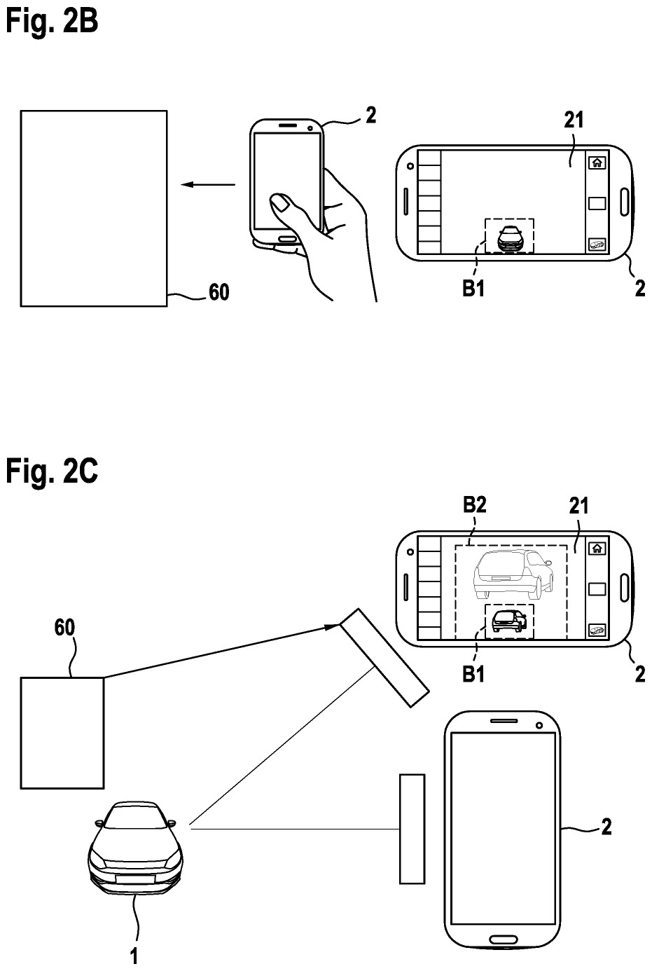

FIG. 1 to 2C both a sensor device and a sensor method according to the invention described herein;

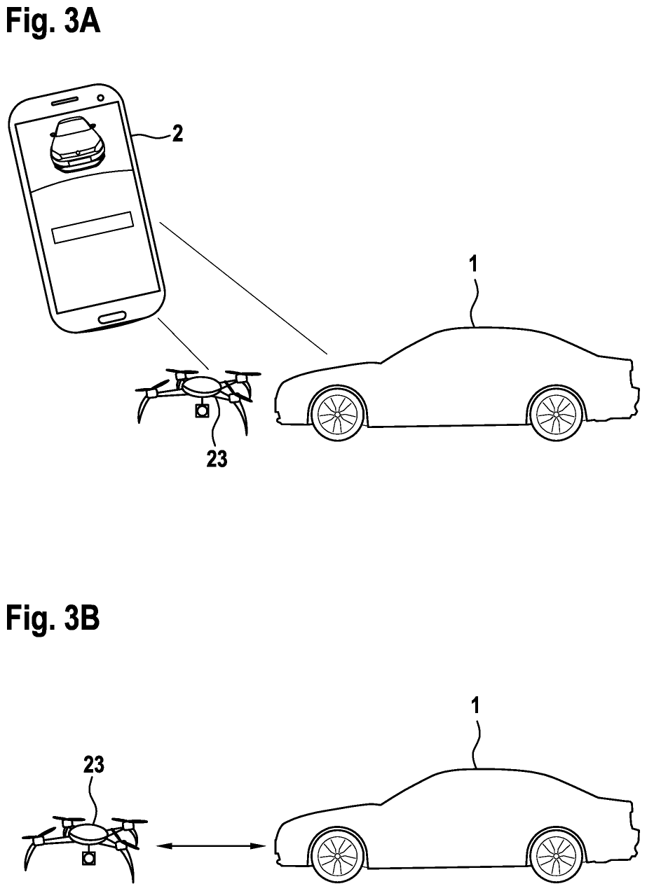

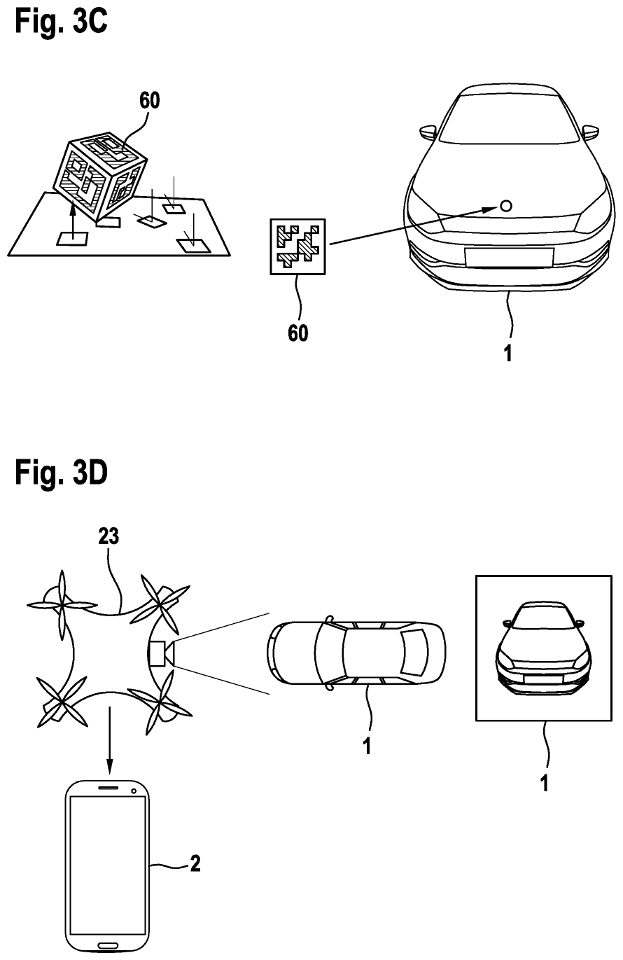

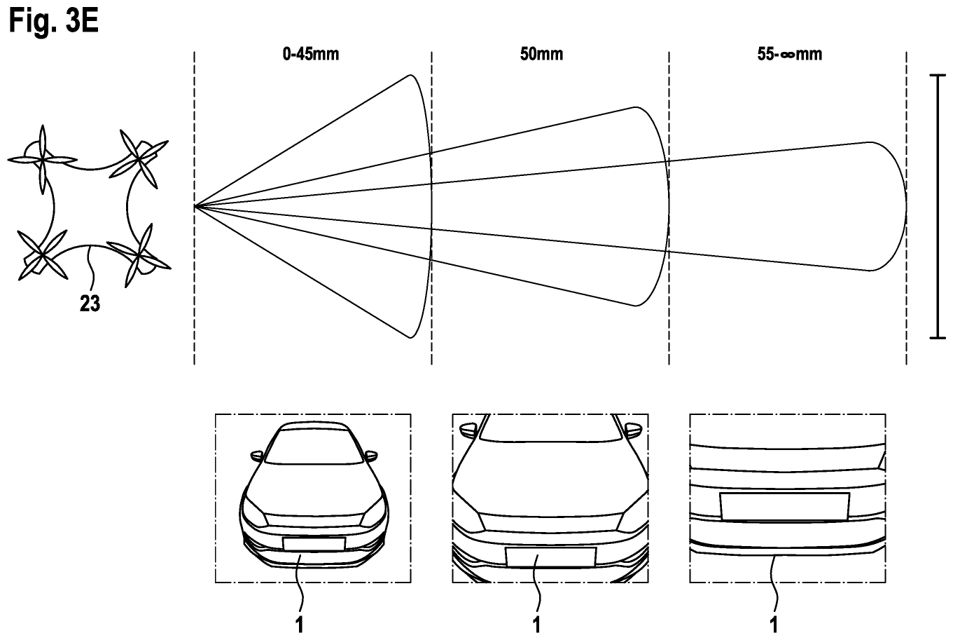

FIGS. 3A to 3E Another embodiment of the sensor method described herein.

In the figures, identical or similarly acting components are each provided with the same reference signs.

In FIG. 1, a sensor method 1000 according to the invention and a sensor device 100 according to the invention are shown, wherein the sensor method 1000 is set up and provided to detect an utilization object 1 in physical terms, in particular optically.

As can be seen from FIG. 1, the sensor method 1000 comprises at least providing an utilization object 1. The utilization object 1 can generally be an object, in particular a three-dimensional object, which is supplied or is to be supplied to or contains an utilization object. In this context, the term “utilize” within the meaning of the application means any handling with regard to a purpose.

In a second step, in particular at least two optical, in particular two-dimensional, sensor images of the utilization object 1 are taken, the images being taken from different angles and/or different positions relative to the utilization object 1 in each case, so that a utilization object image collection of the utilization object 1 is produced and, on the basis of the utilization object image collection and using the optical images, at least one three-dimensional image 30 of the utilization object 1, for example also of its environment, is generated by an implementation device 7, three-dimensional image 30 of the utilization object 1, for example also of its environment, is generated on the basis of the utilization object image collection and using the optical images by an implementation device 7, in particular where, in a further step, at least one processing unit 2 is provided, by means of which the utilization object 1 and/or an identification tool 11 clearly, preferably unambiguously, assigned to the utilization object 1 is physically detected, from which at least one characteristic value 3 of the utilization object 1 is obtained, in particular so that the safety distance between two adjacent objects, in particular utilization objects 1, is maintained.

The characteristic value 3 can be a real number greater than 0, but it is also conceivable that the characteristic value 3 is composed of various partial characteristic values. An utilization object 1 may therefore have, for example, a partial characteristic value with respect to an external colour, a further characteristic value 3 with respect to maximum dimensions in height and width and/or depth, and a further partial characteristic value with respect to weight. For example, such a characteristic value 3 may therefore be formed by the combination of these three partial characteristic values. A combination may take the form of a sum or a fraction. Preferably, however, the characteristic value 3 is determined in the form of a sum of the aforementioned partial characteristic values. However, the individual partial characteristic values can also be included in the summation with different weighting. For this purpose, it is conceivable that each partial characteristic value has a first weight factor as a weight factor, the second partial characteristic value has a second weight factor and a third partial characteristic value has a third weight factor in accordance with the formula:

K=G1*K1+G2*K2+G3*K3,

where the values K1 to K3 represent the respective partial values and the factors G1 to G3 (which represent real positive numbers) denote respective weight factors of the partial characteristic values. The utilization object classification presented here can be a purely optical comparison between the utilization object 1 recorded with a camera mentioned above and a utilization object template stored in a database in an optical manner.

The utilization object classification is performed in that the characteristic value 3 is compared with at least one in a database of the processing unit 2 and/or with a database of an external CPU, and the processing unit 2 and/or the CPU and/or the user himself, selects a database object 4 corresponding to the characteristic value 3 and displays it in a screen 21 of the processing unit 2, so that a camera image of the utilization object 1 together with the database object 4 is at least partially optically superimposed and/or displayed side by side on the screen 21, in particular and further wherein an implementation of at least one physical acquisition process 5, for example by a user and/or an implementation device, in particular at least one camera image, of the utilization object 1, so that the utilization object 1 is captured in such a way that an image of the utilization object 1 captured by the acquisition process is displayed identically or scaled identically with the database object 4 displayed on the screen 21 at the same time, wherein by the acquisition process the usage object 1 is assigned by the processing unit 2 and/or the CPU and/or the user to at least one utilization object class, for example a vehicle type.

FIG. 2A shows an exemplary first step, wherein on the utilization object 1 shown there, which is represented in the form of a smartphone, a utilization object class (for example the images 30), in particular in the form of an example vehicle type, is visually represented on the screen 21. The example vehicle type is not only shown in a reduced form in area B1 on the screen 21, but is also shown in an enlarged form, for example a 1:1 form, with a grey shaded background on the screen 21 (see area B2).

This optically represented utilization object class, i.e. this represented vehicle type, serves as an orientation to the object to be photographed. Also shown is a control 40, by adjusting which a contrast and/or a brightness of the orientation image, that is, in particular, the images 30, each corresponding to an optical representation of a utilization object class is represented. In this way, problems that arise when the brightness is high can be eliminated.

This three-dimensional image 30 is then an approximation image formed basically by the accurately imaged two-dimensional images and by image transition regions, the transition regions connecting the two-dimensional images to form the three-dimensional image 30.

FIG. 2B shows a characteristic recording based on a utilization plate 50 of the utilization vehicle. Here, the utilization plate 50 is optically scanned by the processing unit 2. Depending on the utilization object 1 to be photographed, the angle at which the processing unit 2, exemplified here as a smartphone, must be held changes, whereby optimum quality can be achieved for the comparison and classification process.

FIG. 2C shows, in a further embodiment, that the processing unit 2 must be held in various angular positions relative to the utilization object 1.

Therefore, the above represents not only the physical acquisition process 5, but also the input-described characteristic acquisition for utilization object classification.

In FIG. 3, in a further embodiment, it is shown that the processing unit 2 is attached to a acquisition element 23, in this case a drone, which moves relative to the utilization object 1 according to the specifications by the acquisition sequence. The processing unit 2 may therefore move together with the acquisition element 23 relative to the utilization object 1 according to the acquisition sequence. Although in such a case, the processing unit 2 may be or comprise a smartphone or a camera and the processing unit 2 may still be a manageable processing unit 2. However, this is attached to a larger unit, namely the acquisition element 23. Preferably, the acquisition element 23 comprises all necessary components to be able to move along the utilization object 1 fully automatically or by manual force of the user.

According to at least one embodiment, the acquisition element 23 is a drone which is steered relative to the utilization object 1 according to the acquisition sequence, in order to be able to carry out the individual images preferably along or at the aforementioned marking elements 60

FIG. 3A therefore depicts not only a drone 23, but likewise again the processing unit 2 and the utilization object 1, wherein a drone 23 is first entered a distance into the processing unit 2 beforehand or is predetermined by the acquisition sequence when a drone is launched.

For example, the acquisition sequence captures an instruction to an implementation device and/or a user to photograph the utilization object 1 at different angles, different distances with different colour contrasts, or the like to facilitate identification with a utilization object 1 stored in the database.

Before the drone can orient itself automatically and without a drone pilot, it requires information about the utilization of use 1. The drone can then be placed at a defined distance in front of the vehicle 11 (see FIG. 3B) in order to fly over all the positions according to the acquisition sequence with the aid of the vehicle dimensions in relation to the starting point. In FIG. 3C, corresponding marking elements 60 are shown, which are either attached to the utilization object 1 or are virtually optically “superimposed”.

Such marking elements 60 may therefore also be passive components. However, it is also conceivable that such marking elements 60 can be detachably applied, for example glued, to the utilization object 1. Such utilization objects 1 may have their own power supply, for example a battery supply. Such battery-powered marking elements 60 may emit electromagnetic radiation in the optically visible or in the invisible, for example infrared or microwave range, which may be detected by a locating element of the processing unit 2 and whereby the processing unit 2 is able to determine in which position it is located relative to the usage object 1.

Alternatively or additionally, however, it is also conceivable that the marking elements 60 are virtual marking elements 60 which are loaded from the database and which, like the utilization object 1 itself, are displayed from the database as an image 30, for example as a third image 30 together with a camera image of the utilization object 1 and, accordingly, an appearance of the utilization object 1 loaded virtually from the database, on the screen 21 of the utilization object 1, may therefore, just like the database objects 4 (which may represent the usage objects 1 in virtual terms and which are stored in the database), also be stored as further database objects 4 in the database of the processing unit 2 and/or the external CPU. For example, with one and the same characteristic value 3, both the utilization object 1) and the further database object 4 (at least one marking element 60) can be loaded together into the processing unit 2 and/or displayed on the screen 21 of the processing unit 2.

The marking can be so-called ARUCo marking. These can be high-contrast symbols that have been specially developed for camera applications. These may include not only orientation aids, but also information. With such a marker, the drone 23 can therefore recognize the starting point of the drone flight itself.

In FIG. 3D, a further sequence of the drone flight is shown, which is also evident from FIG. 3E. However, in FIG. 3E it is additionally shown visually how a focal length of a lens, of the processing unit 2 transported by the drone 23, affects the recording quality. On the leftmost utilization object 1 shown, this was recorded with a wide-angle camera, while the utilization object 1 shown in the middle was recorded with a normal-angle camera and the rightmost utilization object 1 was recorded with a telephoto camera. The wide-angle camera may allow a distance of 0 to 45 mm from the utilization vehicle 2, the normal angle camera may allow a distance of about 50 mm, and a telephoto lens may allow a distance of 55 mm or more.

Using natural points, such as the corners or edges of the utilization object 1, and at least one known distance, such as a wall length, a coordinate system can be defined. If the images 30 have GPS information, as in the case of photos of drones, the definition of the coordinate system can be done entirely automatically by georeferencing.

Afterwards there is the possibility to define the point cloud in its borders. Thus, no unnecessary elements, which, for example, were visible in the background of the photos, interfere with the further use of the point cloud. These boundaries are comparable to a clipping box.

Indeed, focal lengths smaller than 50 mm and larger than 50 mm can produce different distortion and distortion effects. Due to the different use of focal lengths of, for example, 6 mm, visible distortions thus occur in the captured images 30, in order to have a comparison of all images 30 subsequently, post-processing of the captured camera images should not take place, so that the above-mentioned different lenses must be used.

The invention is not limited on the basis of the description and the examples of embodiments, rather the invention covers every new feature as well as every combination of features, which also includes in particular every combination of the claims, even if this feature or this combination itself is not explicitly reproduced in the claims or the examples of embodiments.

### LIST OF REFERENCE SIGNS

1 Utilization object
2 Processing unit
3 Characteristic value
4 Database object
5 Physical acquisition process
6 Implementation device
7 Identification tool
21 Screen
23 Acquisition element (drone)
30 Images
40 Controller
50 Utilization badge
60 Marking elements
B1 Area
B2 Area
100 Sensor device
1000 Sensor method

1. Sensor method (1000) for the physical, in particular optical, detection of at least one utilization object (1), in particular for the detection of an environment for generating, in particular a safety distance between objects, comprising the following steps:
provision of the utilization object (1),
carrying out at least two optical, in particular two-dimensional, sensor images of the utilization object (1), the images being taken each from different angles and/or different positions relative to the utilization object (1), so that an utilization object image collection of the utilization object (1) is formed,
characterized in that
at least one three-dimensional image of the utilization object (1), for example also of its environment, is generated by an implementation device (7) on the basis of the utilization object image collection and using the optical images, in particular where, in a further step, at least one processing unit (2) is provided, by means of which the utilization object (1) and/or an identification tool (11) clearly, preferably unambiguously, assigned to the utilization object (1) is physically detected, from which at least one characteristic value (3) of the utilization object (1) is obtained, in particular so that the safety distance between two adjacent objects, in particular utilization objects (1), is maintained.

2. Sensor method (1000) according to claim 1,
characterized in that
the three-dimensional image is an approximation image formed basically by the accurately taken two-dimensional images and image transition regions, the transition regions connecting the two-dimensional images to form the three-dimensional image.

3. Sensor method (1000) according to claim 2,
characterized in that
the transition regions are, in optical terms, a pixel-like (mixed) representation of two directly adjacent edge regions of the two-dimensional images.

4. Sensor method (1000) according to claim 2,
characterized in that
a transition region is formed as a sharply definable dividing line between the two two-dimensional images.

5. Sensor method (1000) according to claim 1,
characterized in that
each two-dimensional image is decomposed into individual data, preferably data classes, and based on this data class generation, the data classes are assembled to form the three-dimensional image, in particular using an AI machine.

6. Sensor method (1000) according to claim 5,
characterized in that
the data classes are assembled into data class point clouds to generate the three-dimensional image.

7. Sensor method (1000) according to claim 1,
characterized in that
the utilization object classification is performed in that the characteristic value (3) is compared with at least one in a database of the processing unit (2) and/or with a database of an external CPU, and the processing unit (2) and/or the CPU and/or the user himself, selects a database object (4) corresponding to the characteristic value (3) and displays it on a screen (21) of the processing unit (2), so that a camera image of the utilization object (1) together with the database object (4) is at least partially optically superimposed and/or displayed next to each other on the screen (21), in particular and further wherein carrying out at least one physical acquisition process (5), for example by a user and/or an implementation device, in particular at least one camera image, of the object of use (1), so that the utilization object (1) is acquired in such a way that an image of the utilization object (1) acquired by the acquisition process is displayed identically or scaled identically to the database object (4) displayed on the screen (21) at the same time, wherein
by the acquisition process, the utilization object (1) is assigned by the processing unit (2) and/or the CPU and/or the user to at least one utilization object class, for example a vehicle type.

8. Sensor method (1000) according to claim 7,
characterized in that
the physical acquisition process (5) comprises at least one temporal acquisition sequence, wherein during the acquisition sequence at least two different acquisitions of the utilization object (1) being carried out, wherein each acquisition being associated with at least one database object (4).

9. Sensor method (1000) according to claim 8,
characterized in that
at least one temporal sequential acquisition instruction of the temporal acquisition sequence for acquiring the at least two images is scanned on the screen (21) after the characteristic acquisition and for the utilization object classification.

10. Sensor device (100) for the physical, in particular optical, detection of at least one utilization object (1), in particular for the detection of an environment for generating, in particular a safety distance between objects, comprising:
provision of the utilization object (1),
At least one acquisition unit for carrying out at least two optical, in particular two-dimensional, sensor images of the utilization object (1), wherein the images being taken each from different angles and/or different positions relative to the utilization object (1), so that a utilization object image collection of the utilization object (1) is formed,
characterized in that
by means of an implementation device (7), starting from the utilization object image collection and using the optical images, at least one three-dimensional image of the utilization object (1), for example also of its environment, can be generated, in particular wherein by means of a processing unit (2) by means of which the utilization object (1) and/or an identification tool (11) clearly, preferably unambiguously, assigned to the utilization object (1) can be physically detected, from which at least one characteristic value (3) of the utilization object (1) can be obtained, in particular so that the safety distance between two adjacent objects, in particular utilization objects (1), can be maintained.
